(19) United States
(12) Patent Application Publication
(10) Pub. No.: US 2014/0297383 A1
(43) Pub. Date: Oct. 2, 2014

(54) INFORMATION PROCESSING APPARATUS, PRICE CALCULATION METHOD, AND RECORDING MEDIUM

(71) Applicant: FUJITSU LIMITED, Kawasaki-shi (JP)

(72) Inventor: Junichi Mashiko, Kawasaki (JP)

(73) Assignee: FUJITSU LIMITED, Kawasaki-shi (JP)

(21) Appl. No.: 14/202,132

(22) Filed: Mar. 10, 2014

(30) Foreign Application Priority Data
Mar. 29, 2013 (JP) 2013-074733

(51) Int. Cl. G06Q 30/02

(52) U.S. Cl. CPC G06Q 30/0226
USPC 705/14.27

(57) ABSTRACT

An information processing apparatus including: a storage unit to store product information that includes a selling price of a product, store card information that includes information on a reward rate of a reward card issued by a store, and payment card information that includes information on a reward rate of a card used for payment; and a processing unit to calculate obtained points obtained by purchasing the product according to the product information, the store card information, and the payment card information, to calculate a cash-converted value that is the obtained points converted into a cash value, and to calculate a real selling price by subtracting the cash-converted value from the selling price.

### CROSS-REFERENCE TO RELATED APPLICATION

This application is based upon and claims the benefit of priority of the prior Japanese Patent Application No. 2013-074733, filed on Mar. 29, 2013, the entire contents of which are incorporated herein by reference.

### FIELD

The embodiments discussed herein are related to an information processing apparatus, a price calculation method, and a price calculation program.

### BACKGROUND

Presently, many types of reward cards are used at many stores, and, by purchasing a product, a customer can obtain points that depend on the type and the price of the product. Some modes of payment, such as credit card, also provide points.

The customer can decrease a price to be paid by using the points in future purchases of products.

In this way, by purchasing a product, a customer can obtain points usable in the future, and hence, taking into consideration the points, the real price can be considered to be lower than the selling price.

Websites are used that have products and the selling prices registered therein and that allow selling prices at stores to be compared.

Customers determine which store a product should be purchased at by consulting a website that allows selling prices to be compared.

However, conventional websites that allow selling prices to be compared only display selling prices, and obtainable points vary according to stores.

Thus, it is difficult for customers to ascertain a real price by simply checking a selling price, thereby leading to a problem wherein it is difficult to determine which store a product can be most advantageously purchased at, and it is also difficult to determine what mode of payment is most advantageous.

Patent document 1 Japanese Laid-open Patent Publication No. 2000-132746

Patent document 2 Japanese Laid-open Patent Publication No. 2005-25684

### SUMMARY

According to an aspect of the invention, an information processing apparatus includes a storage unit and a processing unit.

The storage unit stores product information that includes the selling price of a product, store card information that includes information on the reward rate of a reward card issued by a store, and payment card information that includes information on the reward rate of a card used for payment.

According to the product information, the store card information, and the payment card information, the processing unit calculates obtained points obtained by purchasing the product, calculates a cash-converted value that is the obtained points converted into a cash value, and calculates a real selling price by subtracting the cash-converted value from the selling price.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a configuration diagram of a system in accordance with an embodiment.

FIG. 2 is a configuration diagram of a server in accordance with an embodiment.

FIG. 3 illustrates a search-condition setting screen.

FIGS. 4A and 4B illustrate contents of a store information table.

FIG. 5 illustrates a condition list.

FIG. 6 illustrates a price reduction/reward rule.

FIGS. 7A and 7B illustrate contents of a card information table.

FIG. 8 illustrates contents of an information-associating table.

FIG. 9 illustrates contents of a product information table.

FIG. 10 illustrates contents of a coupon information table.

FIG. 11 illustrates contents of a personal information table.

FIG. 12 is the configuration diagram of a client in accordance with an embodiment.

FIG. 13 is a flowchart of a search and price-calculation process in accordance with an embodiment.

FIG. 14 is a detailed flowchart of a search-target determining process.

FIG. 15 is a detailed flowchart of a score calculation process.

FIG. 16 illustrates calculation of discount equivalent amounts.

FIG. 17 illustrates resultant data.

FIG. 18 is a detailed flowchart of a result-displaying process.

FIGS. 19A and 19B illustrate a result display screen.

FIG. 20 is the configuration diagram of an information processing apparatus (computer).

### DESCRIPTION OF EMBODIMENTS

The following will describe embodiments with reference to the drawings.

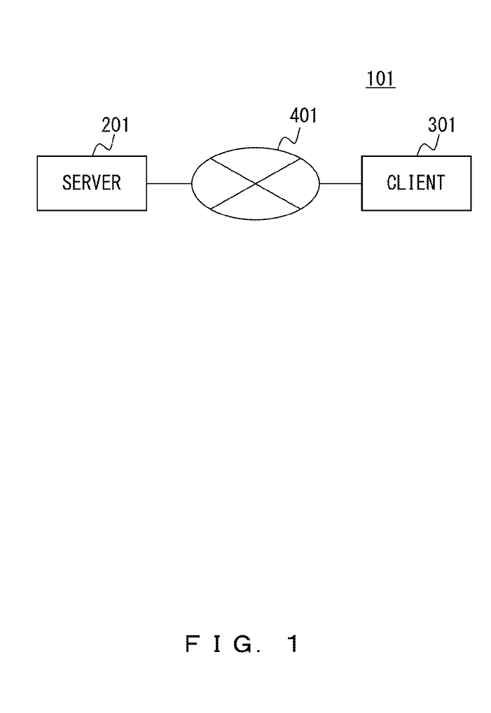

FIG. 1 is a configuration diagram of a system in accordance with an embodiment.

A system 101 includes a server 201 and a client 301.

The server 201 and the client 301 are connected to each other via a network 401 such as a wide area network (WAN) or a local area network (LAN).

The server 201 performs processes of, for example, calculating a real purchase price, sorting a real purchase price order, and generating a search result.

The server 201 is an example of an information processing apparatus.

The client 301 inputs a search condition, displays a search result received from the server 201, and performs other tasks.

The client 301 is an information processing apparatus, e.g., a personal computer (PC), a mobile terminal, a mobile telephone, or a portable game machine.

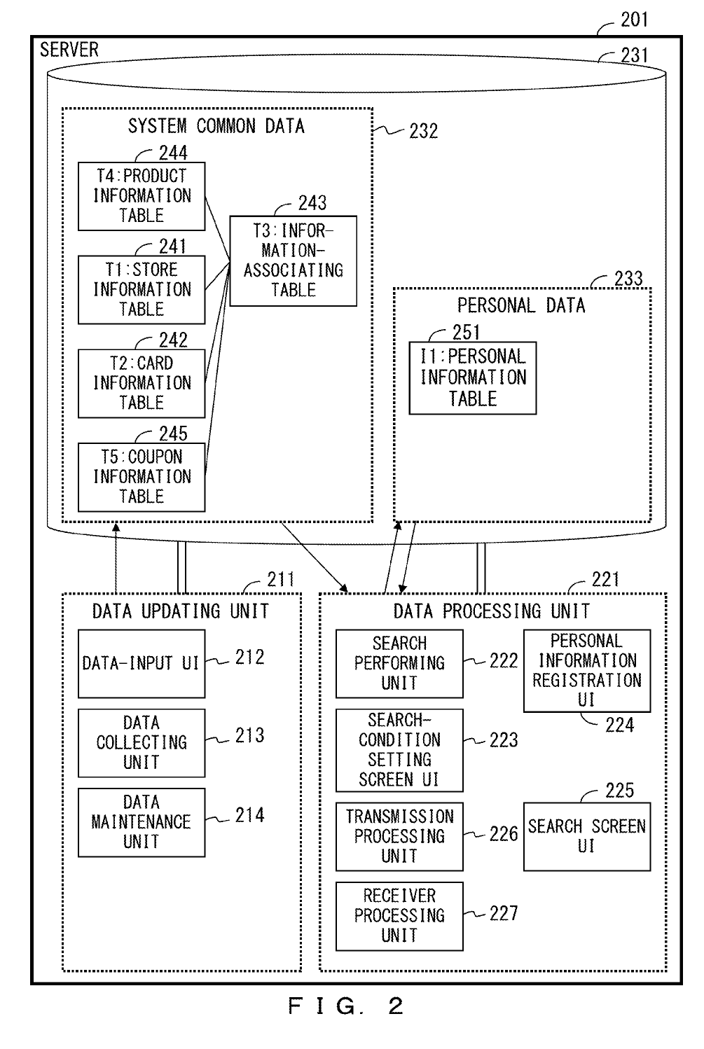

FIG. 2 is a configuration diagram of a server in accordance with an embodiment.

The server 201 includes a data updating unit 211, a data processing unit 221, and a storage unit 231.

The data updating unit 211 includes a data-input user interface (UI) 212, a data collecting unit 213, and a data maintenance unit 214.

The data-input UI 212 performs processes of, for example, generating a data input screen for system common data 232 and reflecting input data in the system common data 232.

The data collecting unit 213 collects and writes selling prices of products in a product information table 244. For example, the data collecting unit 213 periodically accesses a website of a store so as to obtain the selling prices of products from the website, and analyzes a sales-promotion mail so as to obtain the selling price of a product described in the sales-promotion mail.

The data maintenance unit 214 does maintenance on data stored in the storage unit 231. For example, the data maintenance unit 214 checks the effective period of data and deletes data whose effective period has ended.

The data processing unit 221 performs searches, calculates prices, and performs a process of communicating with the client 301.

The data processing unit 221 includes a search performing unit 222, a search-condition setting screen UI 223, a personal information registration UI 224, a search screen UI 225, a transmission processing unit 226, and a receiver processing unit 227.

The search performing unit 222 performs a search according to a search condition and performs processes of, for example, calculating obtainable points, calculating a cash-converted value of points, and calculating a real purchase price.

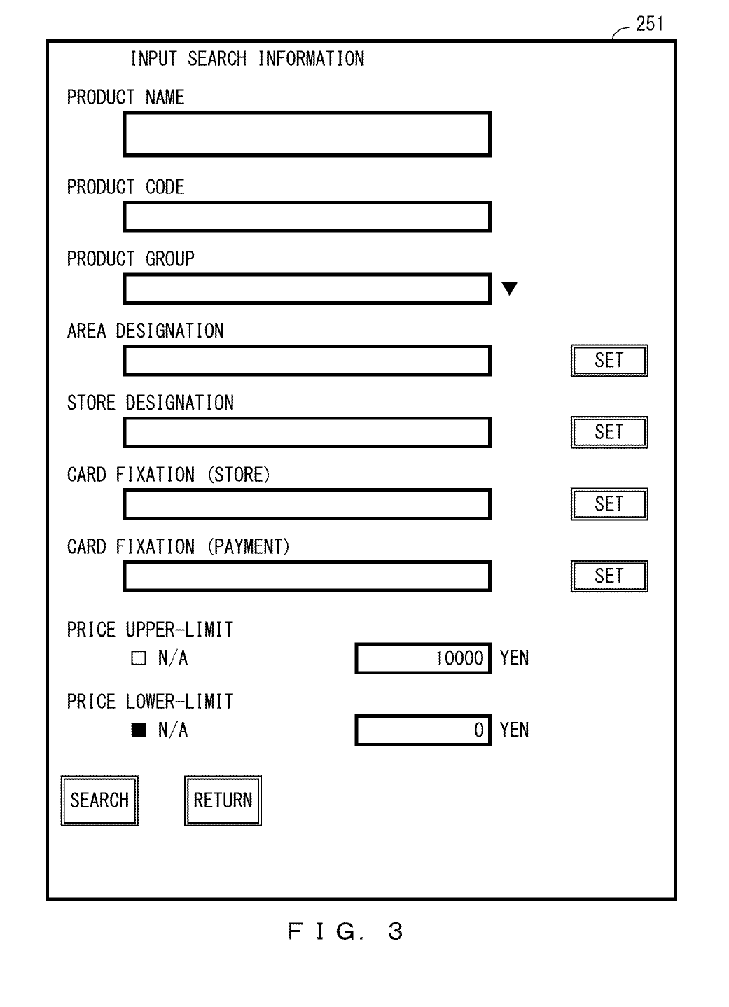

The search-condition setting screen UI 223 generates screen data to input a search condition. The generated screen data is transmitted to the client 301, thereby displaying the search-condition setting screen as illustrated in FIG. 3.

A product name, a product code, a product group, area designation, store designation, card fixation (store), card fixation (payment), a price upper-limit, and a price lower-limit are set as search conditions using the search-condition setting screen in FIG. 3.

The search conditions that are set using the search-condition setting screen in FIG. 3 are mere examples, and hence search conditions to be set are not limited to these.

The personal information registration UI 224 performs a process of registering data in a personal information table 251. The personal information registration UI 224 registers data received from the client 301 in a personal information table 251.

The search screen UI 225 generates, from a search result obtained by the search performing unit 222, display data of the search result. The display data of the search result is transmitted to the client 301 and displayed on a display unit (e.g., liquid crystal display) of the client 301.

The transmission processing unit 226 transmits data to the client 301.

The receiver processing unit 227 receives data from the client 301.

The storage unit 231 is a storage apparatus that stores data.

The storage unit 231 is, for example, a magnetic disk apparatus (hard disk drive), a solid state drive (SSD), or a random access memory (RAM).

The storage unit 231 stores the system common data 232 and personal data 233.

The system common data 232 includes a store information table 241, a card information table 242, an information-associating table 243, a product information table 244, and a coupon information table 245. A plurality of store information tables 241, card information tables 242, information-associating tables 243, product information tables 244, and coupon information tables 245 are present.

The store information table 241 has written therein information on a reward card usable at a store. A reward card usable at a store may hereinafter be referred to as a store-related card.

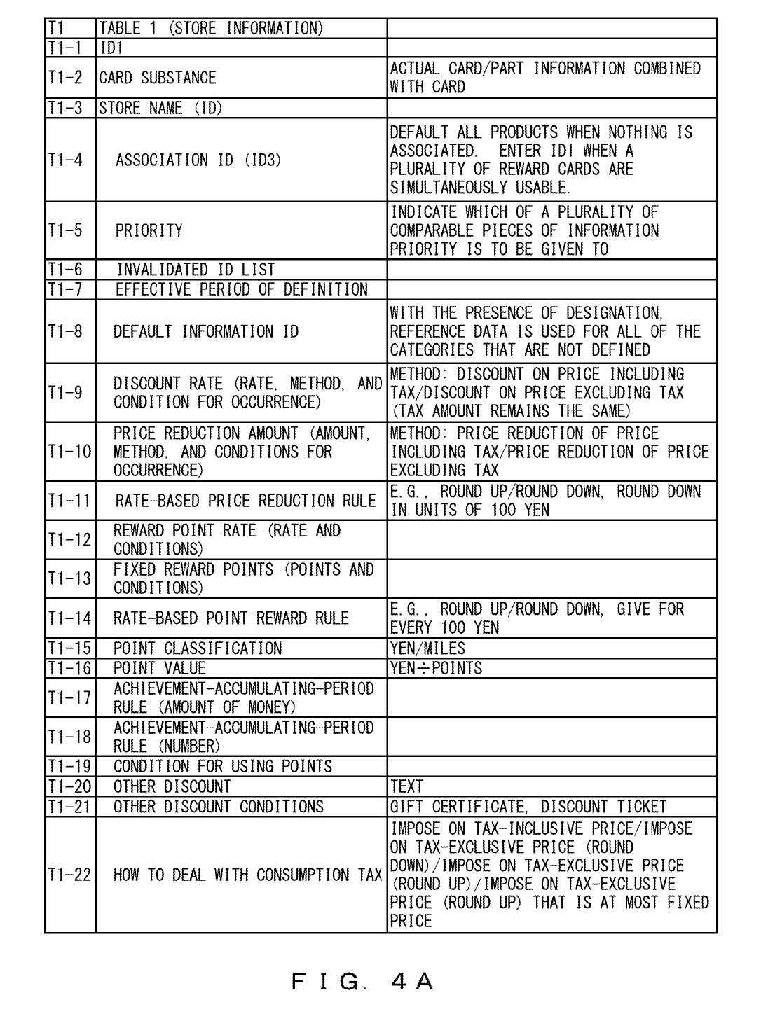

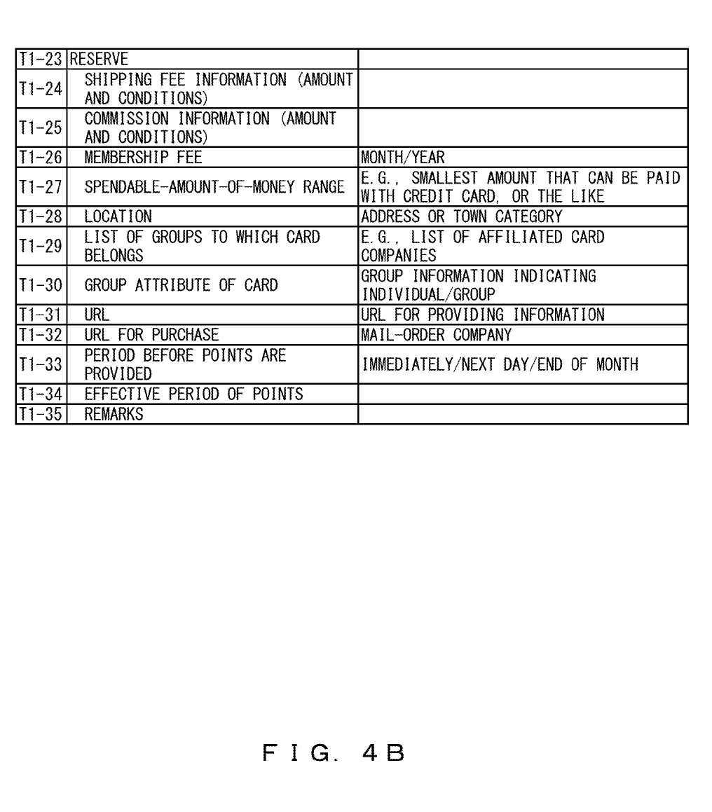

FIGS. 4A and 4B illustrate contents of the store information table 241.

The store information table 241 has written therein an ID1, a card substance, a store name (ID), an association ID (ID3), a priority, an invalidated ID list, an effective period of definition, a default information ID, a discount rate (rate, method, and conditions for occurrence), a price reduction amount (rate, method, and conditions for occurrence), a rate-based price reduction rule, a reward point rate (rate and conditions), fixed reward points (points and conditions), a rate-based point reward rule, a point classification, a point value, an achievement-accumulating-period rule (amount of money), an achievement-accumulating-period rule (number), conditions for using points, other discount, other discount conditions, how to deal with the consumption tax, a reserve, shipping fee information (amount and conditions), commission information (amount and conditions), a membership fee, a spendable-amount-of-money range, a location, a list of groups to which the card belongs, a group attribute of the card, a URL, a URL for purchases, a period before points are provided, the effective period of points, and remarks.

The “ID1” is the identifier (ID) of the store information table 241.

The “card substance” indicates an actual card, or part information combined with a card.

The “store name (ID)” is the name of the store. The ID of the store may be written.

The “association ID (ID3)” is information on an associated table. For example, the ID3 of the information-associating table 243 associated with the store information table 241 is written. When a plurality of store-related cards are simultaneously usable, the ID1s of the store information tables 241 for a plurality of reward cards are written.

The “priority” indicates which of a plurality of comparable pieces of information priority is given to.

The “invalidated ID list” is a list of invalid IDs.

The “effective period of definition” is the effective period of the store information table 241.

The “default information ID” is the ID of a reference table referenced when a category is not defined.

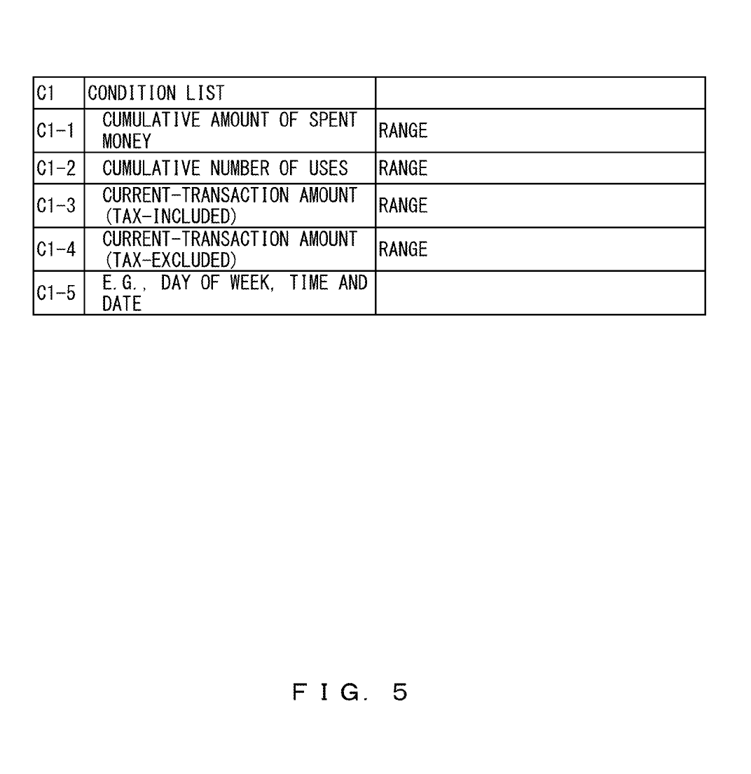

The “discount rate (rate, method, and conditions)” is a discount rate, a discount method, and conditions for discount. The discount method is, for example, a discount on a price including tax or a discount on a price excluding tax (the tax amount remains the same). The conditions are a condition list such as that depicted in FIG. 5. The condition list includes, for example, a cumulative amount of spent money, a cumulative number of uses, a current-transaction amount (tax-included), a current-transaction amount (tax-excluded), a day of the week, and a time and date. The range of the occurrence of a condition is written for, for example, all of the cumulative amount of spent money, the cumulative number of uses, the current-transaction amount (tax-included), the current-transaction amount (tax-excluded), the day of week, and the time and date.

The “price reduction amount (rate, method, and conditions)” is a price reduction amount, a price reduction method, and conditions for price reduction. The price reduction method is, for example, a price reduction of a price including tax or a price reduction of a price excluding tax. The conditions are a condition list such as that depicted in FIG. 5.

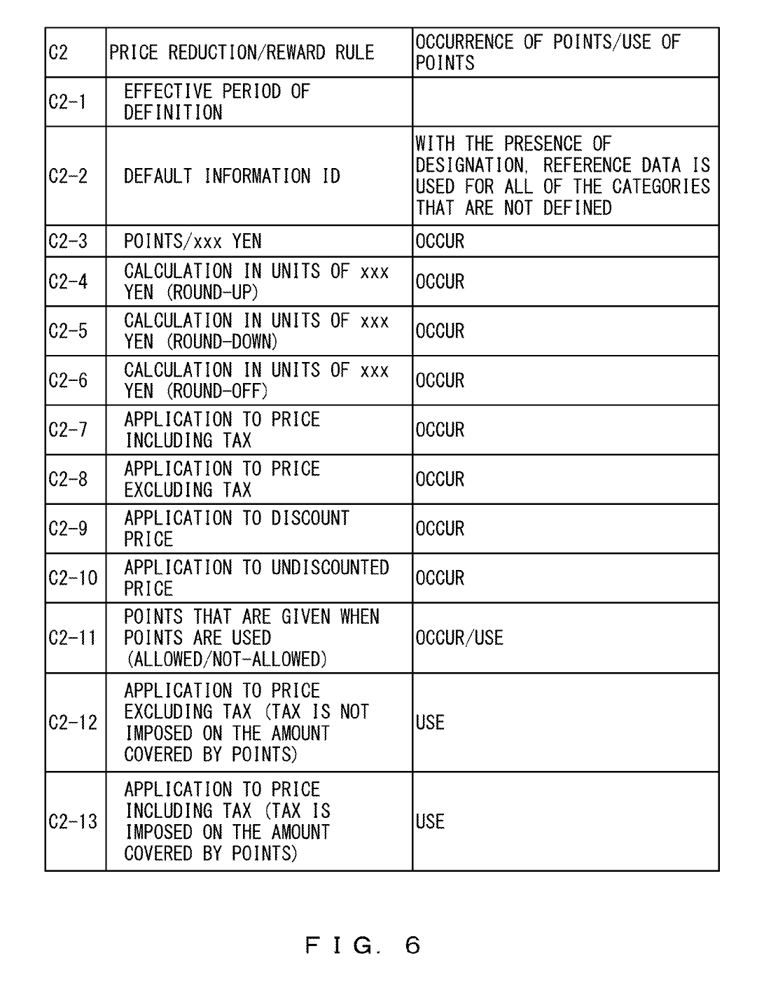

The “rate-based price reduction rule” is a rule used when a price is cut according to a discount rate. The rate-based price reduction rule is a price reduction/reward rule such as that illustrated in FIG. 6. The price reduction/reward rule in FIG. 6 includes an effective period of definition, a default information ID, point/xxx-yen, calculation in units of xxx yen (rounded up), calculation in units of xxx yen (rounded down), calculation in units of xxx yen (rounded off), application to a price including tax, application to a price excluding tax, application to a discount price, application to an undiscounted price, points that are given when points are used (allowed/not-allowed), application to a price including tax (tax is not imposed on the amount covered by points), and application to a price excluding tax (tax is imposed on the amount covered by points). Note that an appropriate value (e.g., 100) is set as xxx.

The “effective period of definition” is the effective period of the price reduction/reward rule, which will be described hereinafter.

The “default information ID” is the ID of a reference table referenced when a category is not defined.

The “point/xxx-yen” is the unit of point calculation. As an example, 10-points/100-yen indicates that a reward of 10 points is given for every 100 yen.

The “calculation in units of xxx yen (rounded up)” indicates whether a digit is to be rounded up after the calculation is done in units of xxx yen.

The “calculation in units of xxx yen (rounded down)” indicates whether a digit is to be rounded down after the calculation is done in units of xxx yen.

The “calculation in units of xxx yen (rounded off)” indicates whether a digit is to be rounded off after the calculation is done in units of xxx yen.

The “application to a price including tax” indicates whether a reward of points is to be given for a price including tax.

The “application to a price excluding tax” indicates whether a reward of points is to be given for a price excluding tax.

The “application to a discount price” indicates whether a reward of points is to be given for a discount price.

The “application to an undiscounted price” indicates whether a reward of points is to be given for an undiscounted price.

The “points that are given when points are used (allowed/not-allowed)” indicates whether reward points occur for the use of points.

The “application to a price excluding tax (tax is not imposed on the amount covered by points)” indicates whether points are used for a price excluding tax.

The “application to a price including tax (tax is imposed on the amount covered by points)” indicates whether points are used for a price including tax.

The contents of the store information table 241 in FIGS. 4A and 4B will be described again.

The “reward point rate (rate and conditions)” is conditions and a rate of points obtainable when a product is purchased. The conditions are as depicted in the condition list in FIG. 5.

The “fixed reward points (points and conditions)” is conditions and fixed points obtainable when a product is purchased. The conditions are as depicted in the condition list in FIG. 5.

The “rate-based point reward rule” is a rule related to points obtainable according to the reward point rate. The rate-based point reward rule is a price reduction/reward rule such as that depicted in FIG. 6.

The “point classification” indicates types of points, which include, for example, “yen” and “miles”.

The “point value” is a cash value that corresponds to one point.

The “achievement-accumulating-period rule (amount of money)” is a rule based on an amount of money paid for a product purchased during a point accumulating period.

The “achievement-accumulating-period rule (number)” is a rule based on the number of purchases made during a point accumulating period.

The “condition for using points” is a condition for using points.

The “other discount” is another discount.

The “other discount conditions” are other discount conditions.

The “how to deal with the consumption tax” indicates how to deal with the consumption tax, which includes, for example, imposing the tax on a tax-inclusive price, imposing the tax on a tax-exclusive price (rounded down), or imposing the tax on a tax-exclusive price (rounded up) that is at most a fixed price.

The “reserve” is an extra category, and, in this example, information is not specifically written.

The “shipping fee information (amount and condition)” is a shipping fee and a condition.

The “commission information (amount and condition)” is a card commission and a condition.

The “membership fee” is a membership fee for a card.

The “spendable-amount-of-money range” is the range of a spendable amount of money.

The “location” is the location of a store. For example, a an address or a town is written as a category.

The “list of groups to which a card belongs” indicates a group to which the card belongs. For example, a list of affiliated card companies is written.

The “group attribute of a card” indicates individual or group.

The “URL” is a URL for providing information.

The “URL for purchase” is the URL of a mail-order company.

The period before points are provided is a time when a user obtains points, which includes, for example, “immediately (i.e., simultaneous with purchase)”, “next day”, and “end of the month”.

The “effective period of points” is the effective period of points.

The “remarks” is reference information related to the store information table 241.

The card information table 242 has written therein information on a payment medium used for payment. The payment medium includes, for example, a credit card, electronic money, cash, and gift tickets.

The payment medium used for payment may hereinafter be referred to as a “payment-related card”.

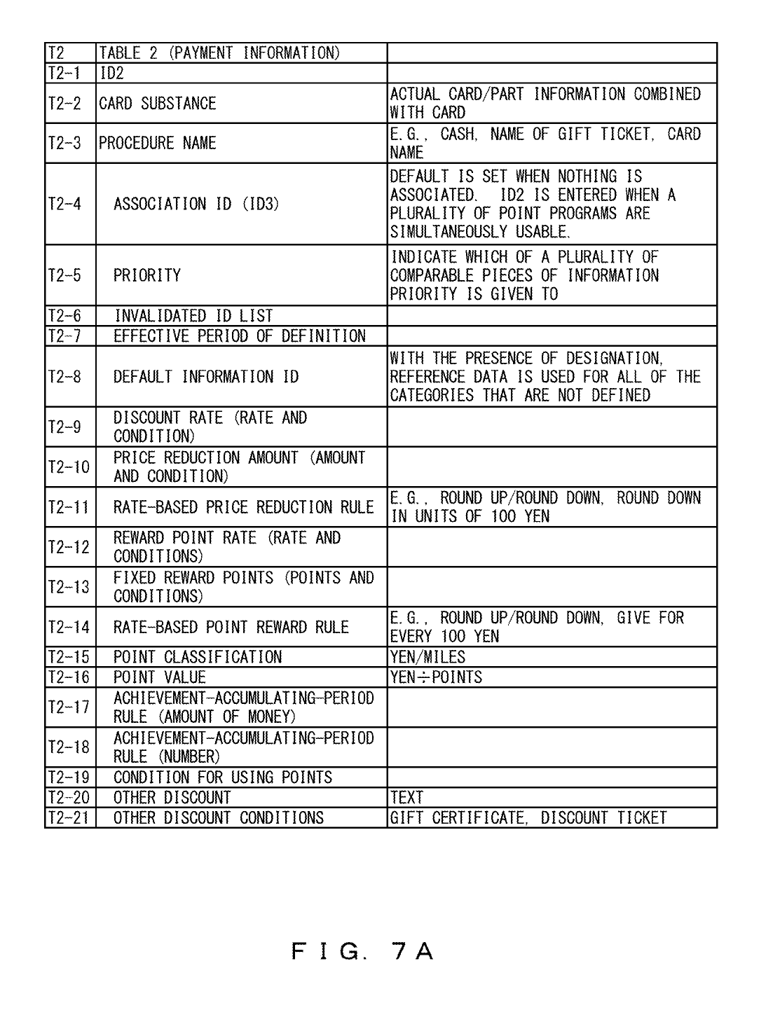

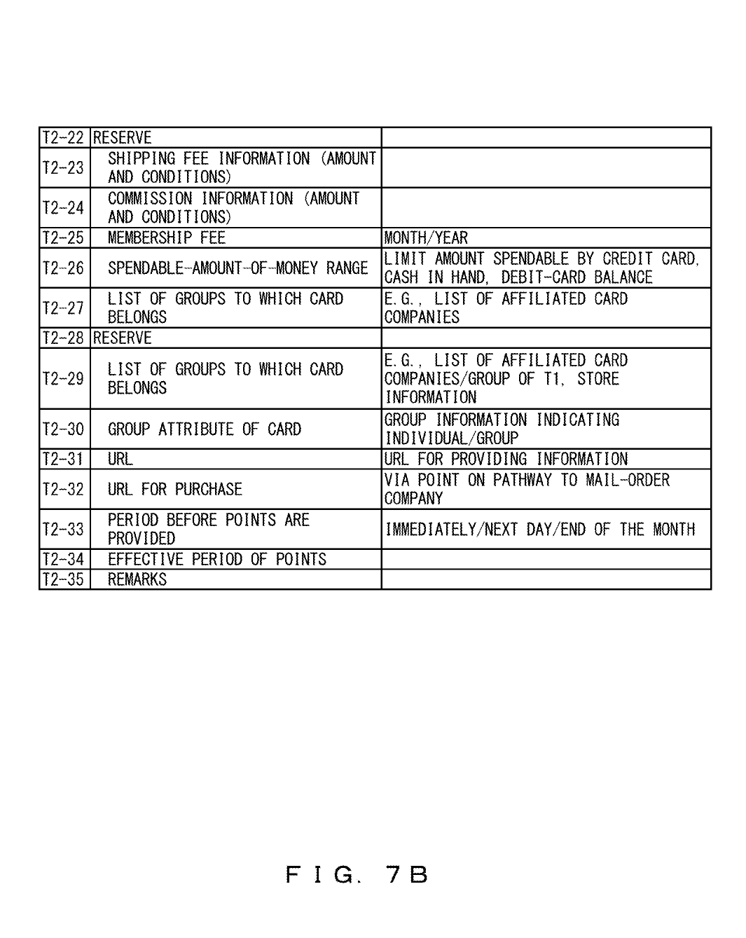

FIGS. 7A and 7B illustrate contents of the card information table 242.

The store information table 242 has written therein an ID2, a card substance, a procedure name, an association ID (ID3), a priority, an invalidated ID list, an effective period of definition, a default information ID, a discount rate (rate and condition), a price reduction amount (amount and condition), a rate-based price reduction rule, a reward point rate (rate and condition), fixed reward points (points and conditions), a rate-based point reward rule, a point classification, a point value, an achievement-accumulating-period rule (amount of money), an achievement-accumulating-period rule (number), conditions for using points, other discount, other discount conditions, a reserve, a card classification, shipping fee information (amount and conditions), commission information (amount and conditions), a membership fee, a spendable-amount-of-money range, a reserve, a list of groups to which the card belongs, a group attribute of the card, a URL, a URL for purchase, a period before points are provided, the effective period of points, remarks, and a data reliability level and data owner.

The “ID2” is the identifier (ID) of the card information table 242.

The “card substance” indicates actual card or part information combined with a card.

The “procedure name” is a name of a payment medium, which includes, for example, cash, the name of a gift ticket, and a card name.

The “association ID (ID3)” is information on an associated table. As an example, the ID3 of the information-associating table 243 associated with the card information table 242 is written. When a plurality of point programs are simultaneously usable, a list of the ID1s and the ID2s is written.

The “priority” indicates which of a plurality of comparable pieces of information priority is given to.

The “invalidated ID list” is a list of invalid IDs.

The “effective period of definition” is the effective period of the card information table 242.

The “default information ID” is the ID of a reference table referenced when a category is not defined.

The “discount rate (rate and conditions)” is a discount rate, a discount method, and conditions for discount. The discount method is, for example, a discount on a price including tax or a discount on a price excluding tax (the tax amount remains the same). The conditions are a condition list such as that depicted in FIG. 5.

The “price reduction amount (rate and conditions)” is a price reduction amount, a price reduction method, and conditions for price reduction. The price reduction method is, for example, a price reduction of a price including tax or a price reduction of a price excluding tax. The conditions are a condition list such as that depicted in FIG. 5.

The “rate-based price reduction rule” is a rule used when a price is cut according to a discount rate. The rate-based price reduction rule is a price reduction/reward rule such as that illustrated in FIG. 6.

The “reward point rate (rate and conditions)” are conditions and a rate of points obtainable when a product is purchased. The conditions are as depicted in the condition list in FIG. 5.

The “fixed reward points (points and conditions)” are conditions and fixed points obtainable when a product is purchased. The conditions are as depicted in the condition list in FIG. 5.

The “rate-based point reward rule” is a rule related to points obtainable according to the reward point rate. The rate-based point reward rule is a price reduction/reward rule such as that depicted in FIG. 6.

The “point classification” indicates types of points, which includes, for example, “yen” and “miles”.

The “point value” is a cash value that corresponds to one point.

The “achievement-accumulating-period rule (amount of money)” is a rule based on an amount of money paid for a product purchased during a point accumulating period.

The “achievement-accumulating-period rule (number)” is a rule based on the number of purchases made during a point accumulating period.

The “conditions for using points” are conditions for using points.

The “other discount” is another discount.

The “other discount conditions” are other discount conditions.

The “reserve” is an extra category, and, in this example, information is not specifically written.

The “card classification” indicates types of cards, which includes, for example, credit cards and prepaid cards.

The “shipping fee information (amount and conditions)” is a shipping fee and conditions.

The “commission information (amount and conditions)” is a card commission and conditions.

The “membership fee” is a membership fee for a card.

The “spendable-amount-of-money range” is the range of a spendable amount of money.

The “reserve” is an extra category, and, in this example, information is not specifically written.

The “list of groups to which a card belongs” indicates a list of groups to which a payment-related card belongs. The list is, for example, a list of affiliated card companies, a store group, or store information.

The “group attribute of a card” is group information indicating individual or group.

The “URL” is a URL for providing information.

The “URL for purchase” is the URL of a mail-order company.

The “period before points are provided” is a time when a user obtains points, which includes, for example, immediately (i.e., simultaneous with purchase), the next day, and the end of the month.

The “effective period of points” is the effective period of points.

The “remarks” is reference information related to the card information table 242.

The “data reliability level and data owner” indicates the reliability level of data and the owner of data.

The information-associating table 243 is information indicating associated tables (the store information table 241, the card information table 242, the product information table 244, and the coupon information table 245).

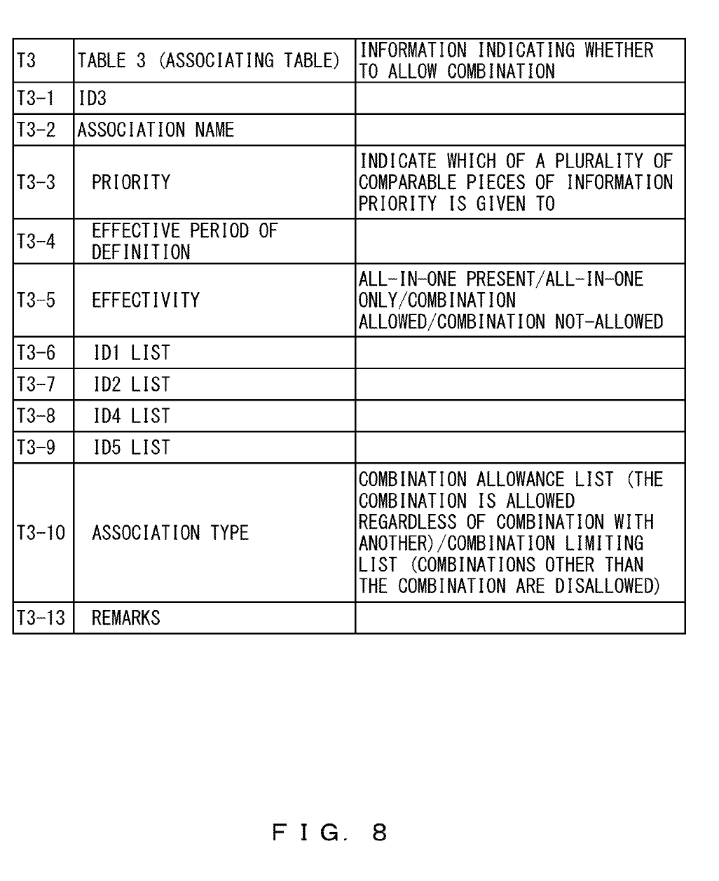

FIG. 8 illustrates contents of the information-associating table 243.

The information-associating table 243 has written therein an ID3, an association name, a priority, an effective period of definition, an effectivity, an ID1 list, an ID2 list, an ID4 list, an ID5 list, an association type, and remarks.

The “ID3” is the identifier (ID) of the information-associating table 243.

The “association name” is a name of association.

The “priority” indicates which of a plurality of comparable pieces of information priority is given to.

The “effective period of definition” is the effective period of the information-associating table 243.

The “effectivity” indicates a meaning of the combination of the following ID lists. The effectivity is, for example, all-in-one is present, all-in-one only, combination allowed, or combination not-allowed.

The “ID1 list” is a list of ID1s of the store information tables 241.

The “ID2 list” is a list of ID2s of the card information tables 242.

The “ID4 list” is a list of ID4s of the product information tables 244.

The “ID5 list” is a list of ID5s of the coupon information tables 245.

The “association type” indicates the type of association. For example, the association type is a combination allowance list that allows the combination regardless of another combination, or a combination limiting list that disallows combinations other than the combination.

The “remarks” is reference information related to the information-associating table 243.

The product information table 244 has product information written therein.

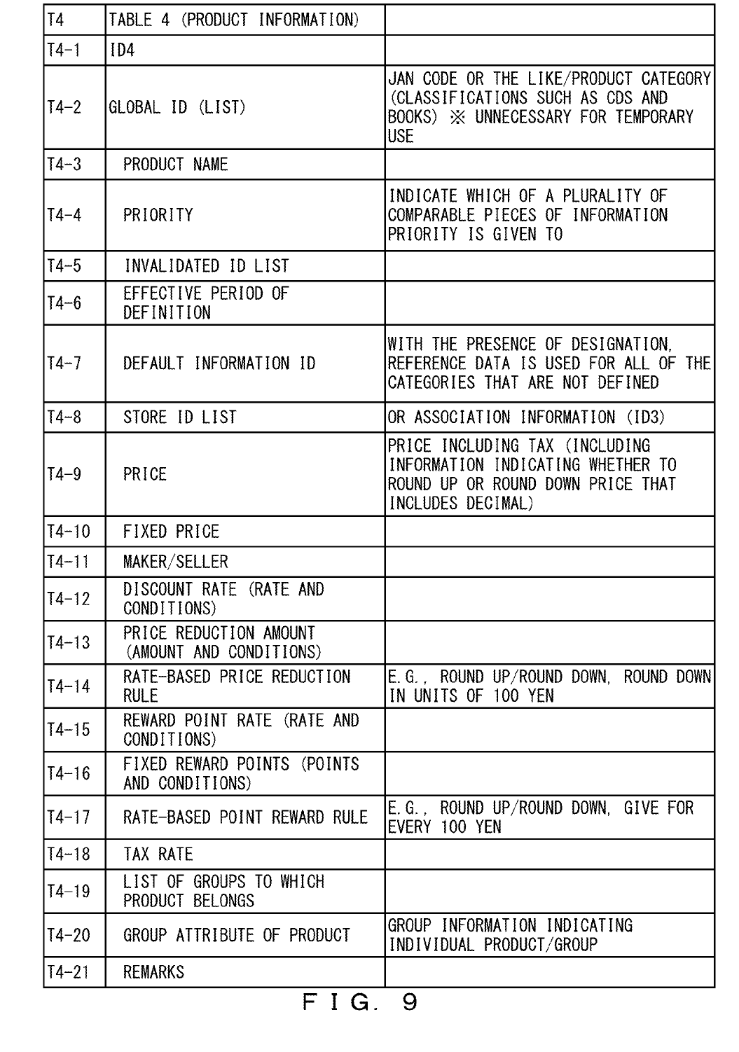

FIG. 9 illustrates contents of the product information table 244.

The product information table 244 has written therein an ID4, a global ID (list), a product name, a priority, an invalidated ID list, an effective period of definition, a default information ID, a store ID list, a price, a fixed price, a maker/seller, a discount rate (rate and conditions), a price reduction amount (amount and conditions), a rate-based price reduction rule, a reward point rate (rate and conditions), fixed reward points (points and conditions), a rate-based point reward rule, a tax rate, a list of groups to which a product belongs, a group attribute of a product, and remarks.

The “ID4” is the identifier (ID) of the product information table 244.

The “global ID (list)” is the ID of a product, which is, for example, a JAN code or the category of the product (classifications such as compact discs (CDs) and books).

The “product name” is the name of a product.

The “priority” indicates which of a plurality of comparable pieces of information priority is given to.

The “invalidated ID list” is a list of invalid IDs.

The “effective period of definition” is the effective period of the product information table 244.

The “default information ID” is the ID of a reference table referenced when a category is not defined.

The “store ID list” is the ID of a store that sells a product. For example, the ID1 of the store information table 241 and the ID3 of the information-associating table 243 are written.

The “price” is the selling price of a product (storefront price). The price also includes information indicating whether to round up or round down a price that includes a number with a decimal point.

The “fixed price” is the fixed price of a product.

The “maker/seller” is the maker and seller of a product.

The “discount rate (rate and conditions)” is a discount rate, a discount method, and conditions for discount. The discount method is, for example, a discount on a price including tax or a discount on a price excluding tax (the tax amount remains the same). The conditions are a condition list such as that depicted in FIG. 5.

The “price reduction amount (amount and conditions)” is a price reduction amount, a price reduction method, and conditions for a price reduction. The price reduction method is, for example, a price reduction of a price including tax or a price reduction of a price excluding tax. The conditions are a condition list such as that depicted in FIG. 5.

The “rate-based price reduction rule” is a rule used when a price is cut according to a discount rate. The rate-based price reduction rule is a price reduction/reward rule such as that illustrated in FIG. 6.

The “reward point rate (rate and conditions)” is conditions and a rate of points obtainable when a product is purchased. The conditions are as depicted in the condition list in FIG. 5.

The “fixed reward points (points and conditions)” is conditions and fixed points obtainable when a product is purchased. The conditions are as depicted in the condition list in FIG. 5.

The “rate-based point reward rule” is a rule related to points obtainable according to the reward point rate. The rate-based point reward rule is a price reduction/reward rule such as that depicted in FIG. 6.

The “tax rate” indicates the tax rate of a tax imposed when a product is purchased, such as the consumption tax.

The “list of groups to which a product belongs” is a list of groups to which a product belongs.

The “group attribute of a product” is group information indicating an individual item or a group.

The “remarks” is reference information related to the product information table 244.

The coupon information table 245 has written therein information on a coupon to discount the price of a product.

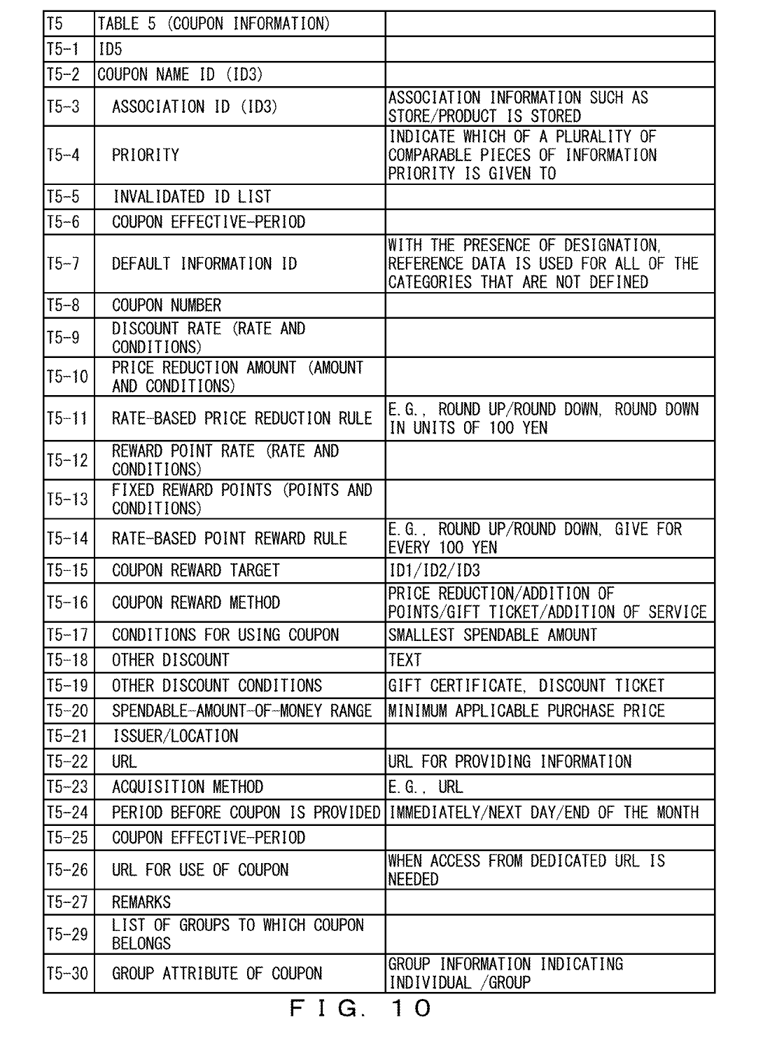

FIG. 10 illustrates contents of the coupon information table 245.

The coupon information table 245 has written therein an ID5, a coupon name (ID), an association ID (ID3), a priority, an invalidated ID list, a coupon effective-period, a default information ID, a coupon number, a discount rate (rate and conditions), a price reduction amount (amount and conditions), a rate-based price reduction rule, a reward point rate (rate and conditions), fixed reward points (points and conditions), a rate-based point reward rule, a point reward target, a coupon reward method, conditions for using points, other discount, other discount conditions, a spendable-amount-of-money range, an issuer/location, a URL, an acquisition method, a period before a coupon is provided, a coupon effective-period, a URL for use of a coupon, remarks, a list of groups to which a coupon belongs, and a group attribute of a coupon.

The “ID 5” is the identifier (ID) of the coupon information table 245.

The “coupon name (ID)” is an ID indicating a coupon.

The “association ID (ID3)” is information on an associated table. For example, the ID3 and the ID4 of the information-associating table 243 and the product information table 244, both associated with the coupon information table 245, are written.

The “priority” indicates which of a plurality of comparable pieces of information priority is given to.

The “invalidated ID list” is a list of invalid IDs.

The “coupon effective-period” is the effective period of a coupon.

The “default information ID” is the ID of a reference table referenced when a category is not defined.

The “coupon number” is a number assigned to a coupon.

The “discount rate (rate and conditions)” is a discount rate, a discount method, and conditions for discount. The discount method is, for example, a discount on a price including tax or a discount on a price excluding tax (the tax amount remains the same). The conditions are a condition list such as that depicted in FIG. 5.

The “price reduction amount (amount and conditions)” is a price reduction amount, a price reduction method, and conditions for a price reduction. The price reduction method is, for example, a price reduction of a price including tax or a price reduction of a price excluding tax. The conditions are a condition list such as that depicted in FIG. 5.

The “rate-based price reduction rule” is a rule used when a price is cut according to a discount rate. The rate-based price reduction rule is a price reduction/reward rule such as that illustrated in FIG. 6.

The “reward point rate (points and conditions)” is conditions and a rate of points obtainable when a product is purchased. The conditions are a condition list such as that depicted in FIG. 5.

The “fixed reward points (points and conditions)” is conditions and fixed points obtainable when a product is purchased. The conditions are a condition list such as that depicted in FIG. 5.

The “rate-based point reward rule” is a rule related to points obtainable according to the reward point rate. The rate-based point reward rule is a price reduction/reward rule such as that depicted in FIG. 6.

The “coupon reward target” indicates a target at which a coupon is rewarded. For example, the ID1, the ID2, the ID3, or the ID4 is written.

The “coupon reward method” indicates a method of giving a coupon as a reward. The method is, for example, a price reduction, the addition of points, a gift ticket, or the addition of a service.

The “conditions for using a coupon” is conditions to use a coupon. The conditions are, for example, a smallest spendable amount and a product group.

The “other discount” is another discount.

The “other discount conditions” are other discount conditions, which are, for example, a gift certificate or a discount ticket.

The “spendable-amount-of-money range” is the minimum price that can be paid with a coupon.

The “issuer/location” is the issuer of a coupon or the location of the issuer.

The “URL” is a URL at which coupon information is provided.

The “acquisition method” is a method of acquiring a coupon, which is, for example, a URL at which the coupon can be acquired.

The “period before a coupon is provided” is a time when the coupon is provided, which includes, for example, the same day, the next day, and the end of the month.

The “coupon effective-period” is the effective period of a coupon.

The “URL for use of a coupon” is a URL used when access is needed from a dedicated URL to use the coupon.

The “remarks” is reference information related to the coupon information table 245.

The “list of groups to which a coupon belongs” is a list of groups to which a coupon belongs.

The “group attribute of a coupon” is group information indicating individual or group.

The personal data 233 includes the personal information table 251. Note that a plurality of personal information tables 251 are present in accordance with the number of registered users.

The personal information table 251 has personal information of a user of the system 101 written therein.

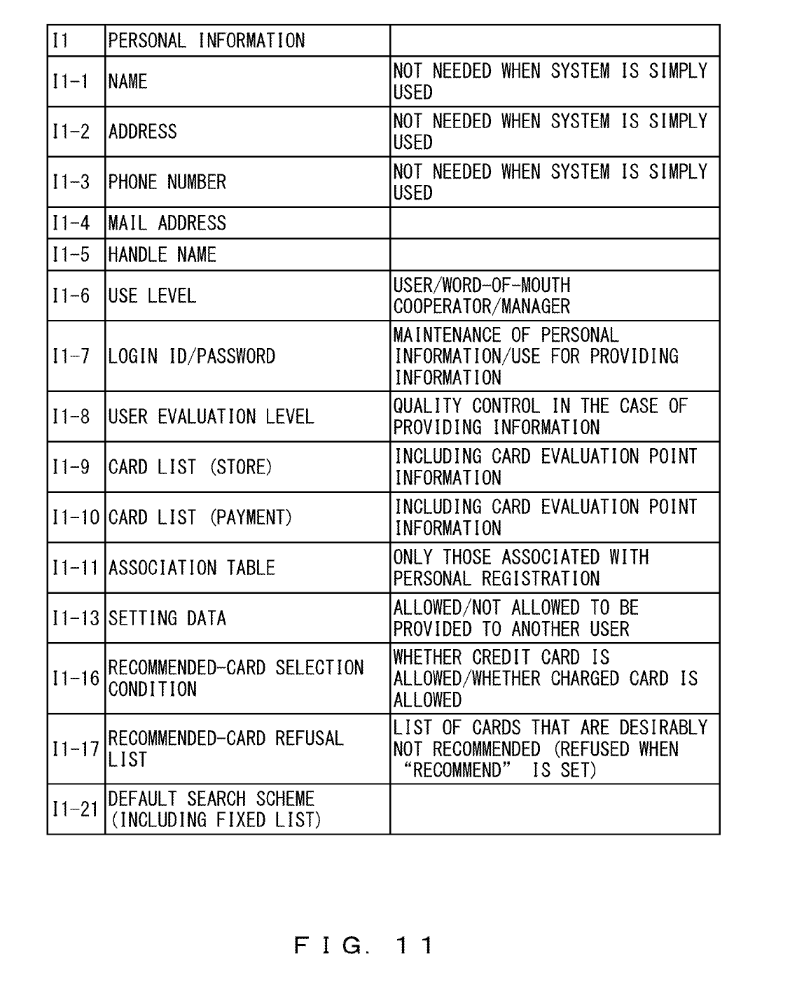

FIG. 11 illustrates contents of the personal information table 251.

The personal information table 251 has written therein a name, an address, a phone number, a mail address, a handle name, a user level, a login ID/password, a user evaluation level, a card list (store), a card list (payment), an associating table, setting data, recommended-card selection conditions, a recommended-card refusal list, and a default search scheme.

The “name” is the name of a user. When the user only uses the system 101, the name is not necessary.

The “address” is an address of a user. When the user only uses the system 101, the address is not necessary.

The “phone number” is a phone number of a user. When the user only uses the system 101, the phone number is not necessary.

The “mail address” is a mail address of a user.

The “handle name” is a handle name of a user.

The “user level” is a level of a user.

The “login ID/password” is a login ID and a password.

The “user evaluation level” is an evaluation of a user.

The “card list (store)” is a list of store-related cards possessed by a user.

The “card list (payment)” is a list of payment-related cards possessed by a user.

The “associating table” is information on an associated table.

The “setting data” indicates whether setting data can be provided to another user.

The “recommended-card selection conditions” is conditions to select a recommended card. The conditions are, for example, credit-card allowed or credit-card disallowed, charged-card allowed or charged-card disallowed, or nonuse.

The “recommended-card refusal list” is a list of cards refused when they are recommended as recommended cards.

The “default search scheme” is default search conditions.

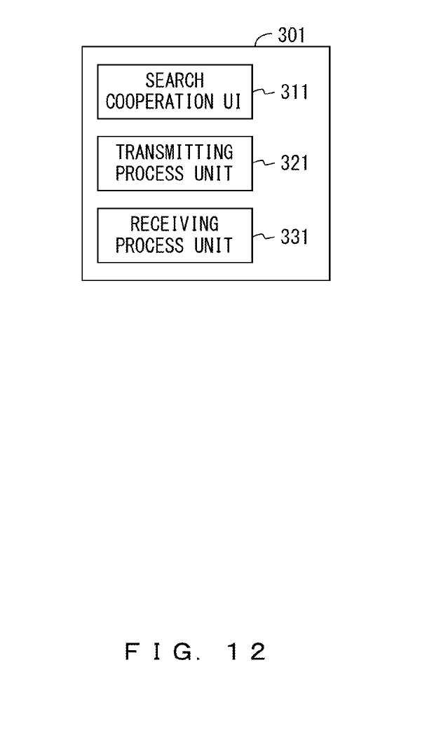

FIG. 12 is the configuration diagram of a client in accordance with an embodiment.

The client 301 includes a search cooperation UI 311, a transmission processing unit 321, and a receiver processing unit 331.

The search cooperation UI 311 performs a process of displaying a search-conditions setting screen on a display unit (not illustrated) and displays a search result received from the server 201 on the display unit. The display unit is, for example, a liquid crystal display or an organic light emitting display.

The transmission processing unit 321 transmits data to the server 201.

The receiver processing unit 331 receives data from the server 201.

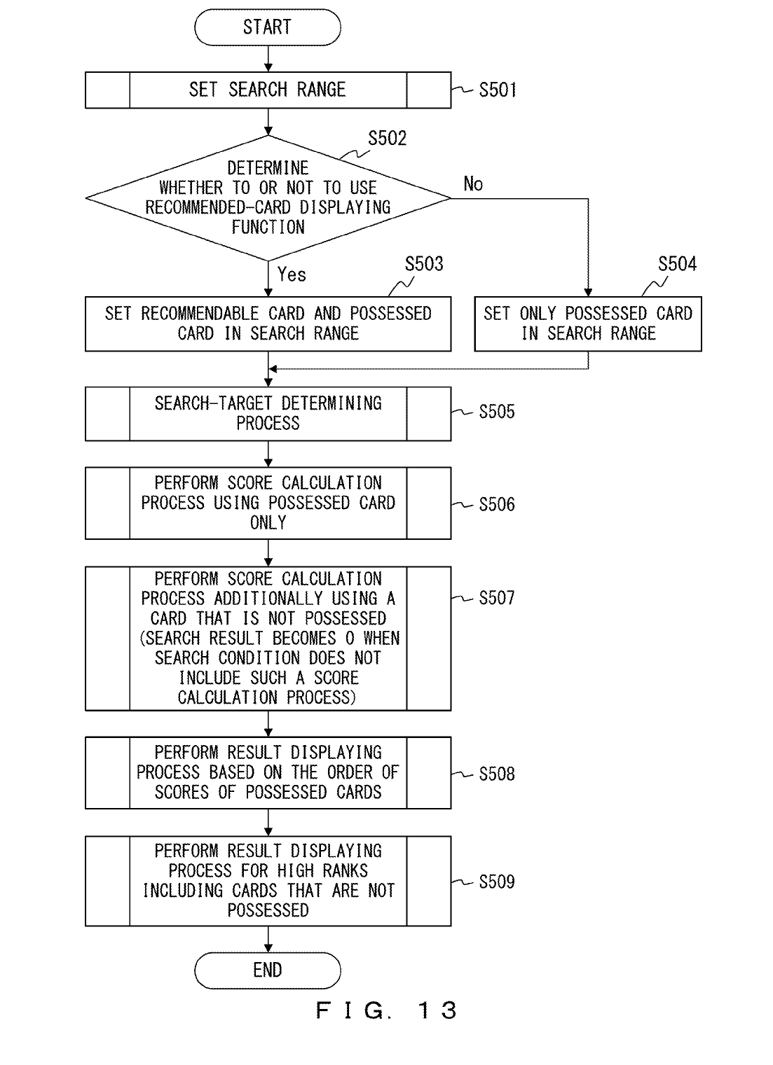

FIG. 13 is a flowchart of a search and price-calculation process in accordance with an embodiment.

First, the search-conditions setting screen UI 223 generates screen data in which search conditions are input. The generated screen data is transmitted to the client 301, thereby displaying a search-conditions setting screen such as that illustrated in FIG. 3. A user inputs and transmits search conditions to the server 201. The data processing unit 221 receives the search conditions.

In step S501, the search performing unit 222 sets the system common data 232 and the personal data 233 as search ranges.

In step S502, the search performing unit 222 determines whether to or not to use a recommended-card displaying function. The control shifts to step S503 when the recommended-card displaying function is used and shifts to step S504 when the recommended-card displaying function is not used. The search performing unit 222 references the recommended-card selection conditions of the personal information table 251 in order to determine whether to or not to use the recommended-card displaying function.

In step S503, the search performing unit 222 sets a card possessed by the user and a recommendable card in the search range. That is, the store information table 241 and the card information table 242 that correspond to the card possessed by the user and the recommendable card are set as the search ranges. The card possessed by the user is stored in the card list (store) and the card list (payment) of the personal information table 251. The recommendable card is designated in accordance with the recommended-card selection conditions of the personal information table 251.

In step S504, the search performing unit 222 sets the card possessed by the user in the search range. That is, the store information table 241 and the card information table 242 corresponding to the card possessed by the user are set as the search ranges.

In step S505, the search performing unit 222 performs a search-target determining process. Details of the search-target determining process will be described hereinafter.

In step S506, the search performing unit 222 performs a score calculation process using the card possessed by the user. Details of the score calculation process will be described hereinafter.

In step S507, the search performing unit 222 performs the score calculation process using the card possessed by the user and a card that is not possessed by the user. Steps S507 and S509 are skipped when the search conditions indicate that a process does not need to be performed on a card that is not possessed by the user.

In step S508, the search performing unit 222 performs a result-displaying process for a score calculated in step S506. Details of the result-displaying process will be described hereinafter.

In step S509, the search performing unit 222 performs the result-displaying process for a score calculated in step S507.

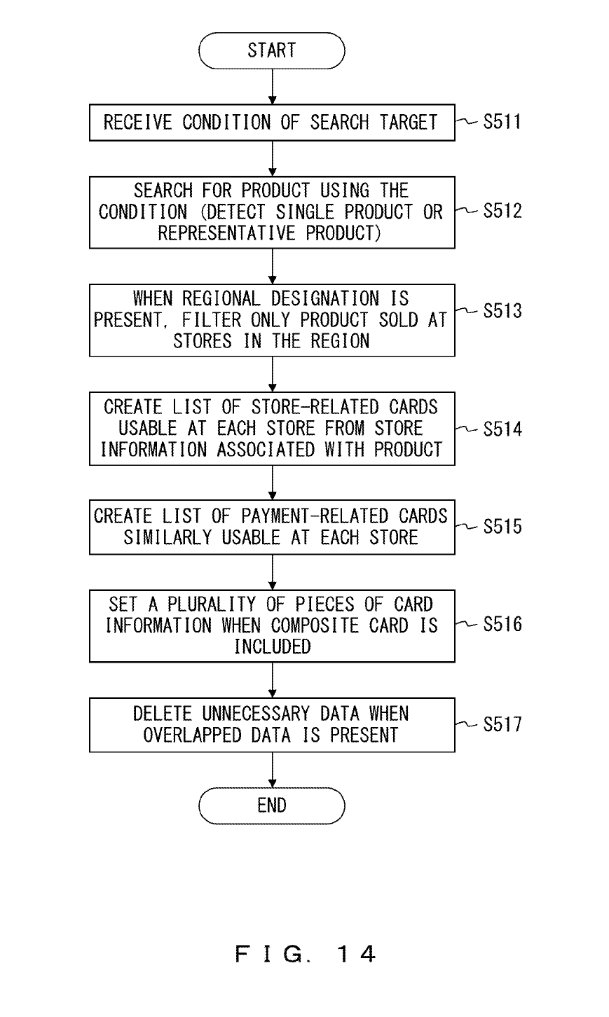

FIG. 14 is a detailed flowchart of a search-target determining process.

The flowchart of FIG. 14 corresponds to step S505 of FIG. 13.

In the search-target determining process, a list of store information tables 241 is made according to a product designated by the search conditions.

In step S511, the search performing unit 222 receives the search conditions from the search cooperation UI 311.

In step S512, the search performing unit 222 searches the product information tables 244 and detects the product information table 244 that corresponds to the product set by the received search conditions.

In step S513, when the search conditions include a regional designation, the search performing unit 222 performs filtering to detect the store information table 241 that corresponds to a store in the region from among stores that sell the product set by the search conditions. The stores that sell the product are stored in the store ID lists of the product information tables 244. The locations of the stores are stored in the locations of the store information tables 241.

In step S514, the search performing unit 222 creates a list of the store information tables 241 detected in step S513. When the search conditions do not include a regional designation, the search performing unit 222 creates a list of the store information tables 241 detected in step S512.

In step S515, the search performing unit 222 references the association ID (ID3) of each store information table 241 included in the created list of the store information tables 241, references the information-associating tables 243 associated with the store information tables 241, and creates a list of card information tables 242 from the ID2 lists of the information-associating tables 243. The ID2 lists of the information-associating tables 243 are the card information tables 242 that correspond to a usable payment-related card.

In step S516, when the store information tables 241 and the card information tables 242 included in the created lists include a composite card, the search performing unit 222 adds information on the composite card to the lists. One possible way to determine whether a composite card is included is to reference the information-associating table 243 associated with the store information table 241 or the card information table 242.

In step S517, when the created lists include overlapped data, the search performing unit 222 deletes overlapped data.

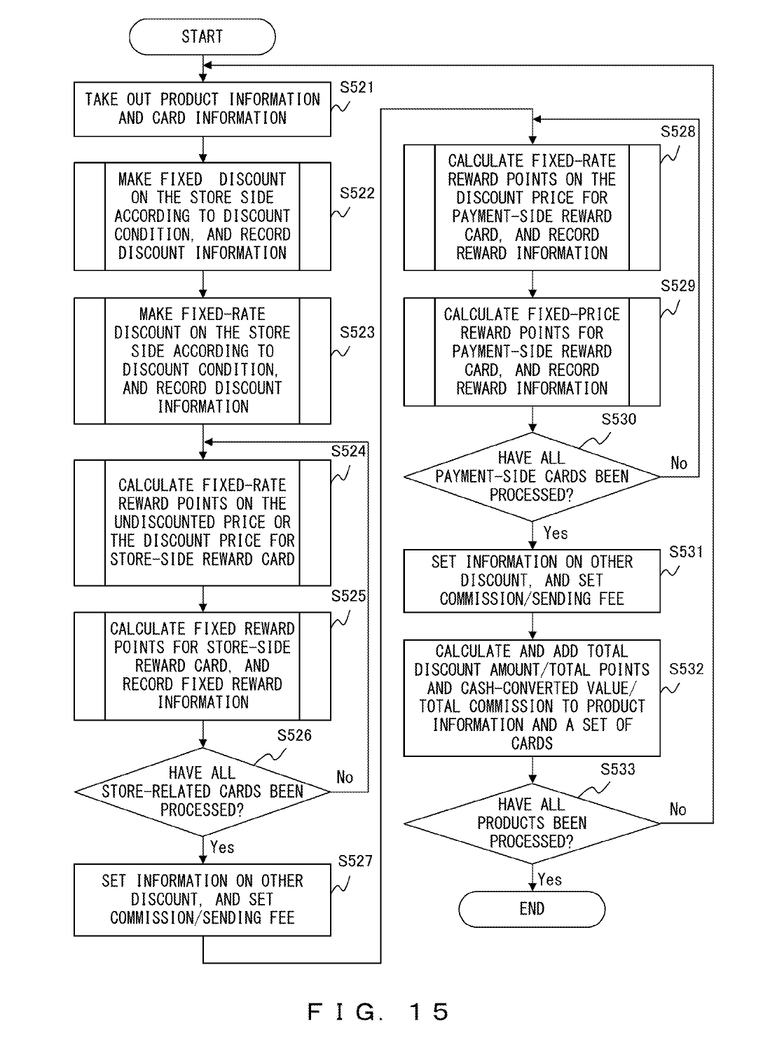

FIG. 15 is a detailed flowchart of a score calculation process.

The flowchart of FIG. 15 corresponds to step S506 or S507 in FIG. 13.

In the score calculation process, information on the product set by the search conditions (i.e., the product information table 244 that corresponds to the product) and a set list of usable cards created in the search-target determining process (the store information table 241 and the card information table 242) are passed as arguments.

In step S506, the search performing unit 222 references the card list (store) and the card list (payment) of the personal information table 251 and extracts and passes, as arguments, a list of cards possessed by the user from among the lists of the usable cards created in the search-target determining process. Then, the score calculation process is performed using a card possessed by the user.

In step S521, the search performing unit 222 takes out one set of information on a product and information on a usable card. Then, processes are performed on the extracted information.

In step S522, the search performing unit 222 references the price reduction amount (amount, method, and conditions) of the store information table 241 and the price reduction amount (amount, method, and conditions) of the card information table 242; when the conditions are satisfied, the search performing unit 222 makes a fixed discount according to the written information and records discount information (price reduction amount).

In step S523, the search performing unit 222 references the price reduction rate (rate, method, and conditions) and the rate-based price reduction rule of the store information table 241 and the discount rate (rate, method, and conditions) and the rate-based price reduction rule of the card information table 242; when the conditions are satisfied, the search performing unit 222 makes a fixed-rate discount according to the written information and records discount information (price reduction amount).

In step S524, the search performing unit 222 calculates fixed-rate reward points on the undiscounted price or the discount price for the store-related card according to the reward point rate (rate and conditions) and the rate-based reward point rule of the store information table 241. That is, the fixed-rate reward points obtainable when the product is purchased are calculated. The rate-based reward point rule of the store information table 241 indicates which of the undiscounted price or the discount price fixed-rate reward points are to be calculated for. In particular, the determination is made using the information written in the “application to discount price” and the “application to undiscounted price” in FIG. 6. The search performing unit 222 also records the fixed-rate reward points.

In step S525, the search performing unit 222 references the fixed reward points (points and conditions) of the store information table 241 and calculates the fixed reward points based on a store-related card.

When the search performing unit 222 has processed all of the store-related cards in step S526, the control shifts to step S527; when the search performing unit 222 has not processed all of the store-related cards in S526, the control returns to step S524.

In step S527, the search performing unit 222 references the “other discount”, the “other discount conditions”, the “shipping fee information (amount and conditions)”, and the “commission information (amount and conditions)” of the store information table 241 and records the discount amount, the shipping fee, and the commission in accordance with the “other discount”.

In step S528, the search performing unit 222 calculates fixed-rate reward points on the discount price for the payment-related card according to the reward point rate (rate and conditions) and the rate-based reward point rule of the card information table 242.

In step S529, the search performing unit 222 references the fixed reward points (points and conditions) of the card information table 242 and calculates the fixed reward points based on the payment-related card.

When all of the payment-related cards have been processed in step S530, the control shifts to step S531; when all of the payment-related cards have not been processed in S530, the control returns to step S528.

In step S531, the search performing unit 222 references the “other discount”, the “other discount conditions”, the “shipping fee information (amount and conditions)”, and the “commission information (amount and conditions)” of the card information table 242 and records the discount amount, the shipping fee, and the commission in accordance with the “other discount”.

In step S532, the search performing unit 222 calculates and adds a total discount amount, total points, a cash-converted value of points (discount equivalent price), and a total commission to information on the product and information on a set of usable cards, generating resultant data.

The following will describe a method for calculating a discount equivalent price and the number of obtained points.

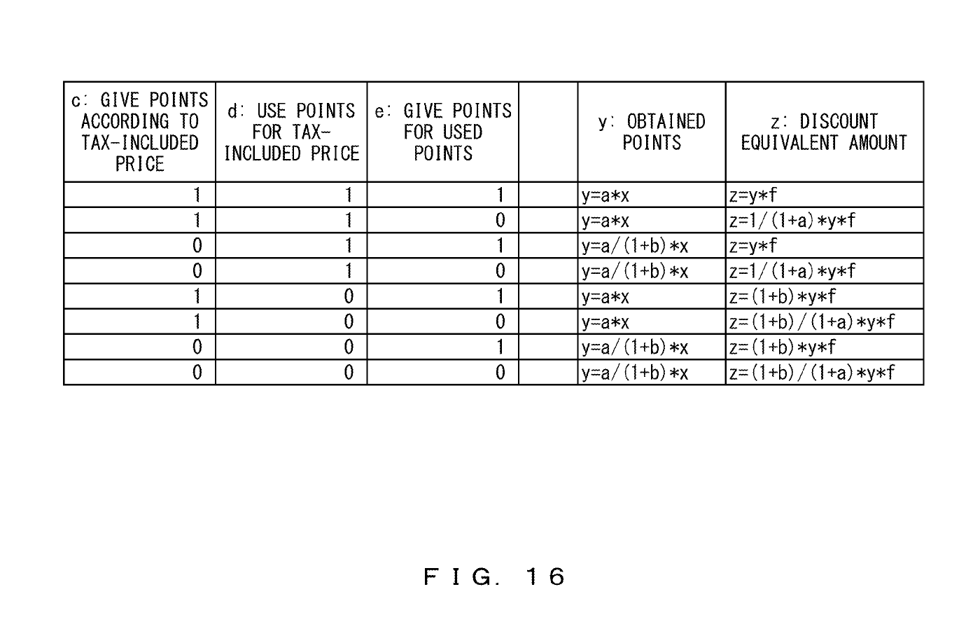

FIG. 16 illustrates calculation of discount equivalent amounts.

Let “a” be a reward rate; “b”, a consumption tax rate; “x”, a tax-included paid amount; “y”, the number of obtained points (fixed-rate reward points); “z”, a discount equivalent amount (cash-converted value); “c”, a value indicating whether points are given according to a tax-included price; “d”, a value indicating whether points are used for a tax-included price; “e”, a value indicating whether points are given for used points; and “f”, a cash value corresponding to one point.

For example, a=0.1 when the reward rate is 10%. b=0.05 when the consumption tax rate is 5%. The reward rate a is stored in the “reward point rate (rate and conditions)” of the store information table 241, and the consumption tax rate b is stored in the “tax rate” of the product information table 244.

The tax-included paid amount, which is the tax-included price of a product, is stored in the “price” of the product information table 244.

c is “1” when points are given according to a price including tax and is “0” when points are given according to a price excluding tax.

d is “1” when points are used for a price including tax and is “0” when points are used for a price excluding tax.

e is “1” when points are given for used points and is “0” when points are not given for used points.

The number of obtained points y and the discount equivalent amount z are calculated using the following formulae.

y=a/(1+b*(1−c))*x

z=(1+b*(1−d))/(1+a*(1−e))*y*f=a/(1+b*(1−c))*(1+b*(1−d))/(1+a*(1−e))*f

In step S533, when all of the products have been processed, the process ends, and, when all of the products have not been processed, the control returns to step S521.

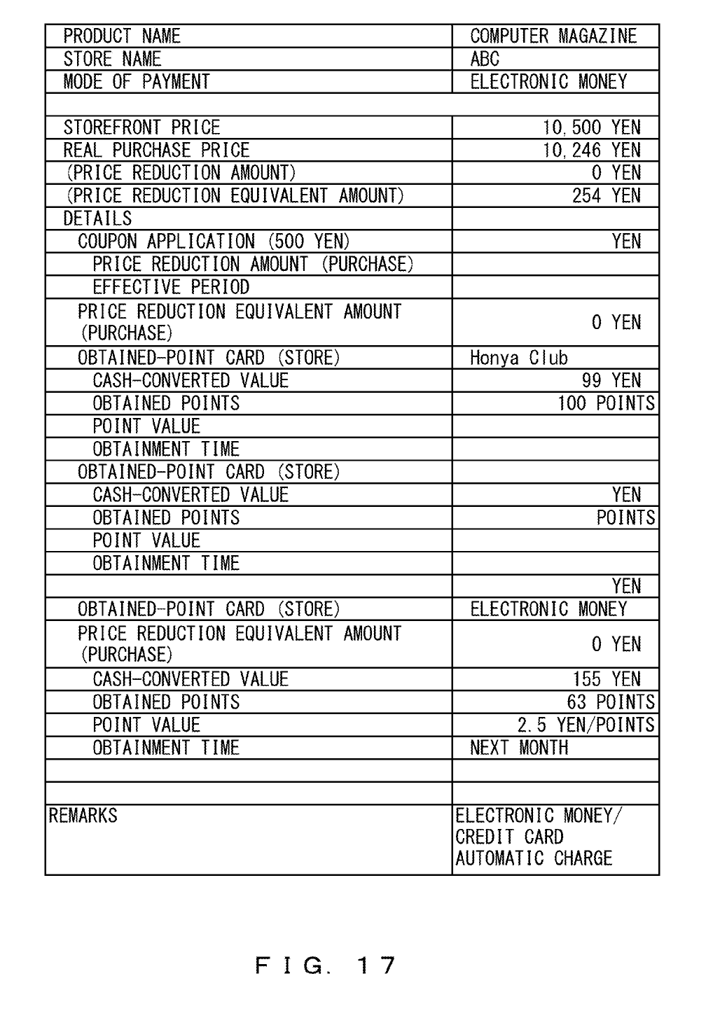

FIG. 17 illustrates the resultant data generated in step S532.

The resultant data depicted in FIG. 17 includes a product name, a store name, a mode of payment, a storefront price, a real purchase price, a (price reduction amount), a (price reduction equivalent amount), a coupon application (500 yen), a price reduction amount (purchase), an effective period, a price reduction equivalent amount (purchase), an obtained-point card (store), a cash-converted value, obtained points, a point value, an obtainment time, an obtained-point card (payment), a price reduction amount (payment), a cash-converted value, obtained points, a point value, and an obtainment time.

The “product name” is the name of a product.

The “store name” is the name of a store.

The “mode of payment” is a payment medium.

The “storefront price” is the tax-included selling price of a product.

The “real purchase price” is a storefront price with a price reduction amount and a price reduction equivalent amount subtracted from this storefront price.

The “(price reduction amount)” is the sum of values discounted according to a coupon or another discount.

The “(price reduction equivalent amount)” is the sum of the cash-converted values of respective obtained points obtainable using a store-related card and a payment-related card.

The “coupon application (500 yen)” indicates the use of a coupon.

The “price reduction amount (purchase)” is a price reduction amount based on a coupon.

The “effective period” is the effective period of a coupon.

The “price reduction equivalent amount (purchase)” is a price reduction amount.

The “obtained-point card (store)”, the “cash-converted value”, the “obtained points”, the “point value”, and the “obtainment time” are information related to a store-related card.

The “obtained-point card (store)” is the name of a reward card.

The “cash-converted value” is a value that is obtainable points converted into a cash value.

The “obtained points” is the number of obtainable points.

The “point value” is the cash value that corresponds to one point.

The “obtainment time” is a time when a point is obtained.

The “obtained-point card (payment)”, the “price reduction amount (payment)”, the “cash-converted value”, the “obtained points”, the “point value”, and the “obtainment time” are information related to a payment-related card.

The “obtained-point card (payment)” is the name of a payment-related card.

The “price reduction amount (payment)” is a price reduction amount for payment.

The “cash-converted value” is a value that is obtainable points converted into a cash value.

The “obtained points” is the number of obtainable points.

The “point value” is the cash value that corresponds to one point.

The “obtainment time” is a time when a point is obtained.

The resultant data of FIG. 17 is given as an example.

When, for example, a shipping fee or a commission is present, the category for the shipping fee or the commission is added, and the value is written in the category.

In another embodiment, the product prices used in the calculations in steps S523, S524, and S528 are fixed. Such a method may be used for a product priced almost identically at stores, e.g., books. In this way, under a condition in which the price of a product is fixed, calculating a discount equivalent amount or a real purchase price for each store or for each mode of payment clarifies which store or mode of payment offers a price advantage.

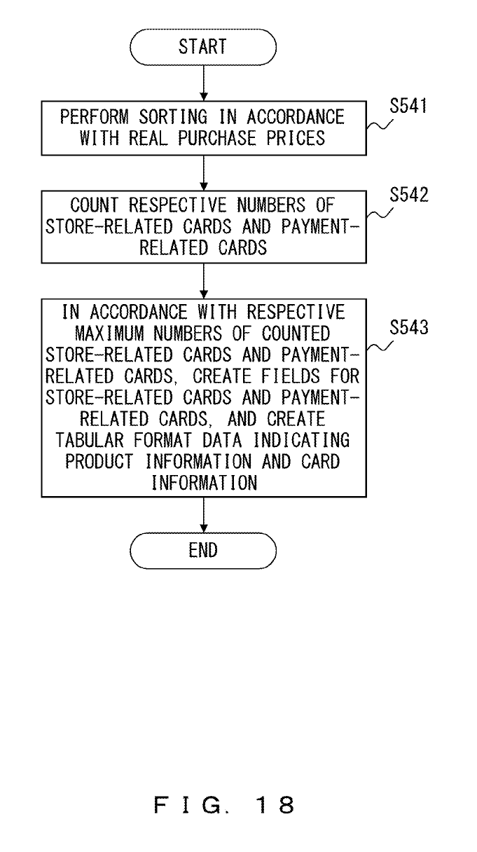

FIG. 18 is a detailed flowchart of a result-displaying process.

FIG. 18 corresponds to step S508 or S509 in FIG. 13.

In step S508, the resultant data generated in step S506 is used, and, in step S509, the resultant data generated in step S507 is used.

In step S541, the search performing unit 222 sorts pieces of resultant data in ascending order of real purchase prices.

In step S542, the search performing unit 222 counts the respective numbers of the store-related cards and the payment-related cards included in each piece of resultant data.

In step S543, in accordance with the respective maximum numbers of the counted store-related cards and the counted payment-related cards, the search performing unit 222 creates fields for the store-related cards and the payment-related cards and creates tabular format data wherein sorted pieces of resultant data are written in the created fields.

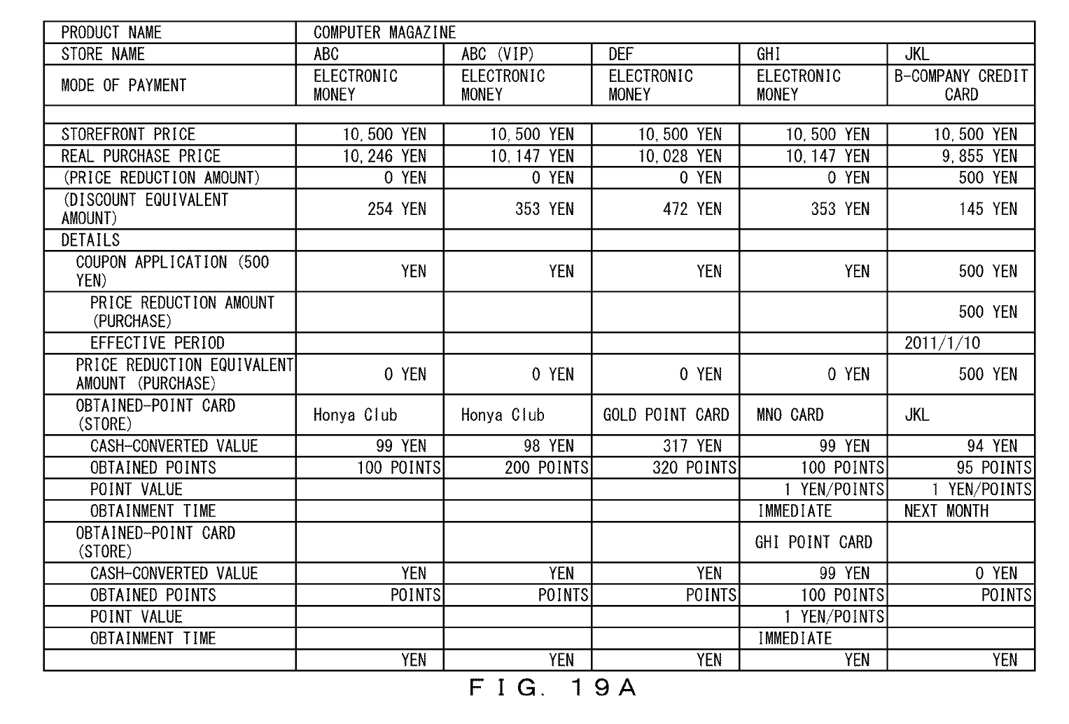

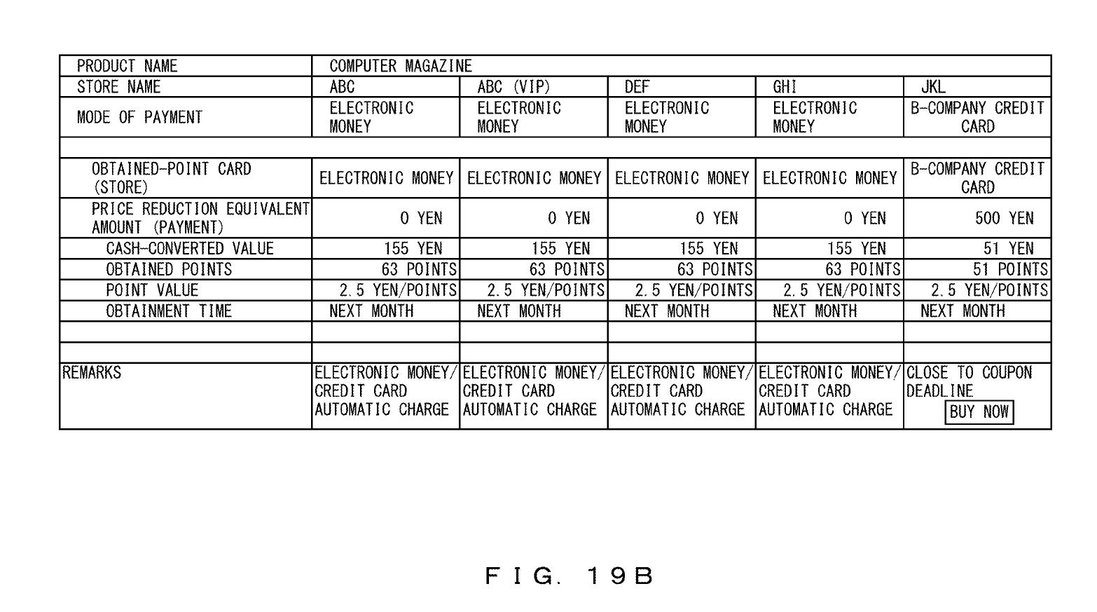

The generated tabular format data is transmitted to the client 301, and a result display screen such as that depicted in FIGS. 19A and 19B is displayed on a display unit of the client 301.

FIGS. 19A and 19B depict a search result for a computer magazine.

As illustrated in FIGS. 19A and 19B, pieces of resultant data sorted in ascending order of real purchase prices are displayed.

In FIGS. 19A and 19B, in the purchasing of a computer magazine by, for example, referencing the result display screen, a user can easily recognize that making a payment with electronic money at a store “ABC” offers the greatest price advantage.

A system in accordance with an embodiment allows points obtained when a product is purchased to be converted into a cash value so that a real purchase price can be calculated by subtracting the cash value from a selling price. Displaying a real purchase price for each store or each mode of payment allows a customer to easily recognize which store or mode of payment offers a price advantage.

In another embodiment, the client 101 may include a function of the server 201, the client 301 may store system common data and personal link data obtained from the server 201, and the client 101 may perform processes such as the aforementioned processes of calculating or displaying a price.

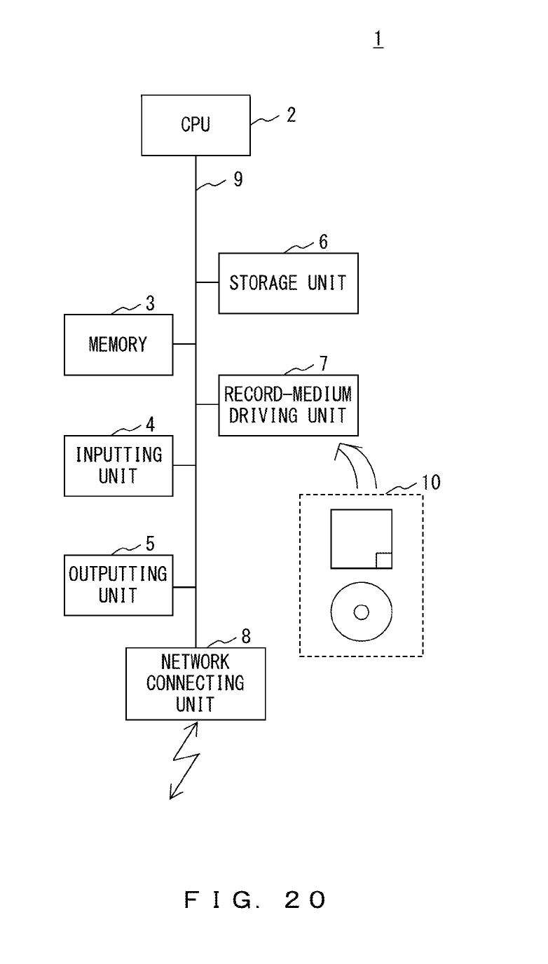

FIG. 20 is the configuration diagram of an information processing apparatus (computer).

The server 201 and the client 301 in accordance with an embodiment may be achieved by, for example, an information processing apparatus 1 illustrated in FIG. 20.

The information processing apparatus 1 includes a central processing unit (CPU) 2, a memory 3, an inputting unit 4, an outputting unit 5, a storage unit 6, a record-medium driving unit 7, and a network connecting unit 8, all of which are connected to each other via a bus 9.

The CPU 2 controls the entirety of the information processing apparatus 1. The CPU 2 corresponds to the data updating unit 211, the data processing unit 221, the search cooperation UI 311, the transmission processing unit 321, and the receiver processing unit 331.

The memory 3 is a memory such as a read only memory (ROM) or a random access memory (RAM) that, during a program execution, temporarily stores a program or data stored in the storage unit 6 (or a portable record medium 10). The CPU 2 performs the aforementioned various processes by executing the program using the memory 3.

In this case, a program code itself read from, for example, the portable record medium 10 achieves a function of an embodiment.

The inputting unit 4 is, for example, a keyboard, a mouse, or a touch panel.

The outputting unit 5 is, for example, a display or a printer.

The storage unit 6 is, for example, a magnetic disk apparatus, an optical disk apparatus, or a tape apparatus. The information processing apparatus 1 saves the aforementioned program and data in the storage unit 6 and, if necessary, reads and loads them into the memory 3. The storage unit 6 corresponds to the storage unit 231.

The record-medium driving unit 7 drives the portable record medium 10 and accesses data recorded in the portable record medium 10. The portable record medium may be an arbitrary computer-readable record medium such as a memory card, a flexible disk, a compact disc read only memory (CD-ROM), an optical disk, or a magneto-optical disk. A user stores the aforementioned program and data in the portable record medium 10 and, if necessary, reads and loads them into the memory 3.

The network connecting unit 8, which is connected to an arbitrary communication network such as a LAN or a WAN, converts data in accordance with a communication.

All examples and conditional language provided herein are intended for pedagogical purposes to aiding the reader in understanding the invention and the concepts contributed by the inventor to further the art, and are not to be construed as being limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a storage unit to store product information that includes a selling price of a product, store card information that includes information on a reward rate of a reward card issued by a store, and payment card information that includes information on a reward rate of a card used for payment; and
a processor to calculate obtained points obtained by purchasing the product according to the product information, the store card information, and the payment card information, to calculate a cash-converted value that is the obtained points converted into a cash value, and to calculate a real selling price by subtracting the cash-converted value from the selling price.

2. The information processing apparatus of claim 1, wherein
the processor
calculates the obtained points for each store obtained by purchasing the product,
calculates the cash-converted value for each store that is the obtained points for each store converted into a cash value,
calculates the real selling price for each store by subtracting the cash-converted value for each store from the selling price for each store,
sorts the real selling prices provided by the stores in ascending order, and
generates a table in which the sorted real selling prices provided by the stores are arranged.

3. The information processing apparatus of claim 2, wherein
the processor defines the selling price of the product for each store as a first price and calculates the obtained points for each store obtained by purchasing the product.

4. The information processing apparatus of claim 1, wherein
the storage unit further includes personal information that includes a list of reward cards issued by a store and possessed by a user and a list of cards possessed by the user and used for payment, and
the processor references the personal information to calculate the obtained points obtained by purchasing the product using the reward card issued by the store and possessed by the user and the card possessed by the user and used for payment.

5. A price calculation method executed by an information processing apparatus that includes a storage unit to store product information that includes a selling price of a product, store card information that includes information on a reward rate of a reward card issued by a store, and payment card information that includes information on a reward rate of a card used for payment, the price calculation method comprising:
calculating obtained points obtained by purchasing the product according to the product information, the store card information, and the payment card information;
calculating a cash-converted value that is the obtained points converted into a cash value; and
calculating a real selling price by subtracting the cash-converted value from the selling price.

6. A non-transitory computer-readable recording medium having stored therein a program for causing a computer to execute a process, the computer including a storage unit to store product information that includes a selling price of a product, store card information that includes information on a reward rate of a reward card issued by a store, and payment card information that includes information on a reward rate of a card used for payment, the process comprising:
referencing the product information, the store card information, and the payment card information;
calculating obtained points obtained by purchasing the product according to the product information, the store card information, and the payment card information;
calculating a cash-converted value that is the obtained points converted into a cash value; and
calculating a real selling price by subtracting the cash-converted value from the selling price.
